(19) United States
(12) Patent Application Publication
(10) Pub. No.: US 2013/0083205 A1
(43) Pub. Date: Apr. 4, 2013

(54) FULL FIELD SHARPNESS TEST

(71) Applicants: Mark N. Gamadia, Longmont, CO (US); Fei Wu, Sunnyvale, CA (US); Shizhe Shen, San Jose, CA (US); Jason Rukes, San Francisco, CA (US)

(72) Inventors: Mark N. Gamadia, Longmont, CO (US); Fei Wu, Sunnyvale, CA (US); Shizhe Shen, San Jose, CA (US); Jason Rukes, San Francisco, CA (US)

(21) Appl. No.: 13/250,646

(22) Filed: Sep. 30, 2011

(51) Int. Cl. H04N 17/06

(52) U.S. Cl. 348/188; 348/E17.002

(57) ABSTRACT

A test chart can be used to test sharpness performance of an imaging system's full image field by having a sharpness inspection area formed of a plurality of identical visual elements that abut each other leaving no gaps to thereby form a mosaic. Each visual element includes a plurality of groups of differently oriented contrasting lines. The mosaic may fill an entire image captured by an imager. Thus, a test system can image the chart to objectively assess the performance of the imaging system in terms of image quality (e.g. sharpness, tilt, etc) throughout the entire spatial area of the captured image. The size of the chart and spatial frequency spacing) of the visual element lines can be selected to test an imaging system's full field sharpness at selected spatial frequencies. The full field sharpness results more quickly and accurately determine different aspects of a given imaging system.

Embodiments of the invention relate to testing the performance of an optical system through the measurement of image quality in a digital imaging system that contains the optical system. More particularly, embodiments of the present invention relate to assessing full field sharpness performance of the imaging system, using a test chart that enables testing sharpness across the entire image field or area of an image that is captured by the imager.

### BACKGROUND

Digital imaging systems (e.g., cameras) have quickly become a standard feature for portable devices including portable multimedia players, smart phones, and tablet computers. The image quality expectations from these portable cameras has grown as higher quality and higher megapixel cameras have been incorporated into such small devices. As portable device dimensions shrink, so does the dimensions of the incorporated camera modules. At such small scales, mass produced camera modules become more susceptible to image quality degradation due to slight deviations and/or contaminations in the optical system components introduced during camera imaging system component assembly. Spatial sharpness uniformity and spatial image tilt are two examples of such detrimental degradations which could arise in such cases.

Several quality analysis metrics may be used to describe different aspects of image quality in a captured, digital image, to identify detrimental degradations during manufacturing test. For one, test systems may measure the sharpness of an image produced by an imaging system. The sharpness may vary in different parts of the captured image, where typically the center of the digital image may be sharper than its corner. Still further, test systems may monitor spatial sharpness uniformity and spatial image tilt.

In such a situation, it is important to have a measurement setup that yields the quality analysis metrics quickly and conveniently in order to maintain a low cost for performing the measurements, particularly for very high volume manufacturing of smaller camera modules such as those used in consumer electronic portable devices such as smart phones and tablet computers. It is also important to have a thorough test of quality analysis metrics to identify detrimental degradations, which could exist in the imaging system.

### SUMMARY

Embodiments of the invention assess sharpness performance of an imaging system by using a test chart having a sharpness inspection area formed of a plurality of identical visual elements that abut each other leaving no gaps to thereby form a mosaic, wherein the visual element is a plurality of groups of differently oriented contrasting lines. The visual element contains groups of different directionally oriented contrasting lines that abut each other leaving no empty spaces between the groups. Each visual element may have a square perimeter around the following groups: a group of horizontal lines in the upper left, a group of diagonal lines in the upper right, a group of vertical lines in the lower right, and a group of anti-diagonal lines in the lower left of the visual element. Other groupings of horizontal, diagonal and vertical lines are possible for the visual element.

The chart can be imaged by a device under test, DUT (e.g. a camera module) to fill the full image field or area of an image that is captured by the DUT's imager. A test system or test process may then objectively assess the performance of the DUT in terms of its ability to maintain a certain level of image quality (e.g. sharpness, tilt, etc) throughout the entire spatial extent of the captured image. An advantage of this design is that the size of the chart along with the spatial frequency (e.g., spacing) of the visual element lines can be selected to test an imaging system's full field sharpness at selected spatial frequencies. Different aspects of image quality and analysis metrics from a given imaging system and its components may be more quickly and accurately determined based on examination of the full field sharpness.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a block diagram of one type of digital imaging system.

FIG. 2A is a representation of a test chart that can be used for the monitoring and measurement of image quality of images captured by an imaging system, in accordance with embodiments of the invention.

FIG. 2B is a close-up view of a test element or visual pattern which is a component of the test chart depicted in FIG. 2A.

FIGS. 3A-C are flow charts showing processes for using a test chart to monitor and measure image quality in a captured image, in accordance with embodiments of the invention.

FIG. 4 is a representation of a test system that can be used for the monitoring and measurement of image quality of an image captured by a digital camera or imaging system, in accordance with embodiments of the invention.

FIG. 5 depicts an example mobile device in which an embodiment of the imaging system can be implemented.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

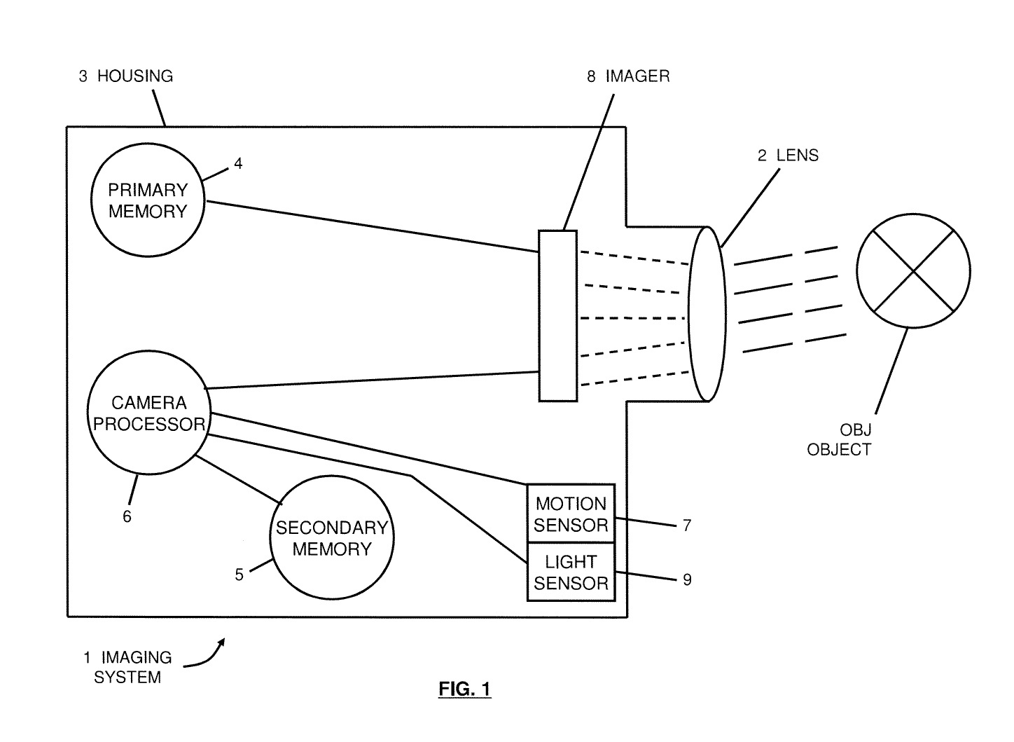

A typical portable device may include an imaging system such as imaging system 1 depicted in FIG. 1. The imaging system includes housing 3 which contains at least one lens 2, a primary memory unit 4, camera processor 6, and at least one image sensor (also referred to as an imager) 8. The primary memory unit 4 can be used to store digital images (e.g., still images and/or video images-frames) and computer software for performing various functions in the imaging system 1. A removable, secondary memory unit 5 in the form of a memory card can also be optionally included in the digital camera to provide extra memory space. Image sensor 8 can be a charge coupled device (CCD), a complementary metal oxide semiconductor (CMOS), or another system as known in the art. The imaging system 1 may optionally also include at least one motion sensor 7 operatively connected to the camera processor 6. The motion sensor may be used to determine a focus distance and/or shutter speed to be used by the camera and imaging system when taking a picture or video. The imaging system 1 may optionally also include at least one light sensor 9 operatively connected to the camera processor 6. The light sensor may be used to determine a shutter speed, image brightness and/or contrast selection to be used by the imaging system when taking a picture (still or video). When a picture or video of an object OBJ in the scene is about to be taken, lens 2 focuses the image onto an area of image sensor 8 which records light electronically. This electronic information is processed (e.g., by processor 6) into digital data (e.g., image frames), which can be stored in memory as still images (e.g., pictures) and/or video (e.g., frames). Video may be synchronized with audio input from a microphone. The imaging system 1 can be a stand-alone device (e.g., a module in housing 3 with electronic connectors); or can have its components incorporated into circuitry of another electronic device, such as a portable device or telephone system.

To maintain the image quality of the final product, a test system or process may be used to objectively test or assess the performance of an imaging system (e.g. optical system) in terms of its ability to maintain a certain level of image quality (e.g. sharpness, tilt, etc) throughout the spatial extent of the captured image. Thus, the performance of an optical system may be tested through the measurement of image quality in a digital imaging system that contains the optical system. This document discloses embodiments of test charts, systems and processes to perform examination of an imaging system's full field sharpness (the sharpness across the entire spatial area possible for a captured image or frame of the imaging system) as a means to facilitate the judgment of different aspects of image quality and analysis metrics from a given imaging system or imaging system component (e.g. optical lens assembly, entire camera module, camera image signal processing process or algorithm, etc). The test system or process uses an image of a test chart or target to assess full field sharpness performance of the imaging system. The chart may be formed of lines of test elements (e.g., visual patterns) on a piece of paper or other substrate.

### The Chart:

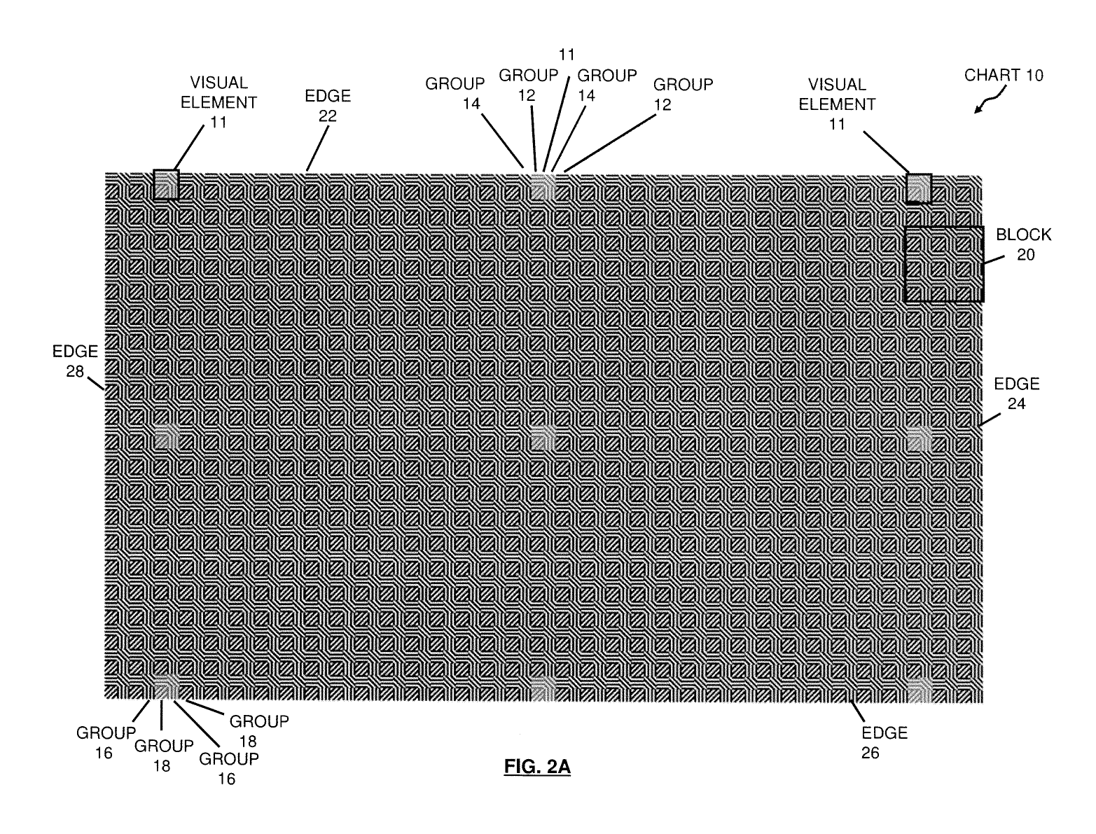

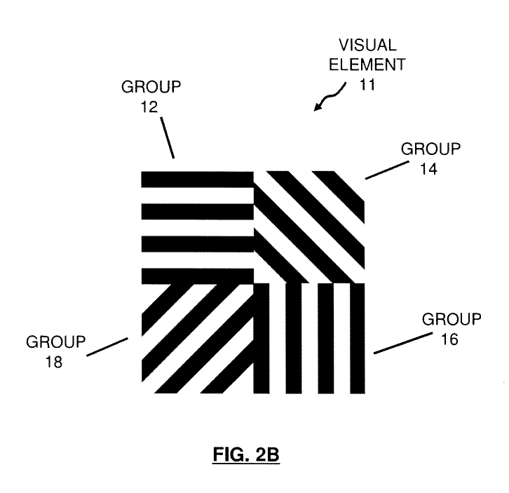

FIG. 2A is a representation of test chart 10 that can be used (e.g., as an image target) for the monitoring and measurement of image quality of an image captured by a digital camera or imaging system, in accordance with embodiments of the invention. In some cases, chart 10 may be referred to as a “B-Chart”. Chart 10 may be used for the objective assessment of the full field sharpness performance of any component of a given imaging system. FIG. 2B is a representation of a test element or visual pattern 11 (e.g., a “B-Feature”) that is a component of the “B-Chart”, in particular a block in the chart and block 20 (e.g., a “B-Block 20”) of the “B-Chart” is composed of a high density of “B-Features” of FIG. 2B, providing a fine sampling of relevant high spatial frequency details suitable for the imaging system or device under test. The B-Feature or itself consists of a certain spatial arrangement of dark and light (to provide enough contrast) bars or line pairs at a specific spatial frequency (spacing) in four principal directions, namely (in clockwise order starting from the upper left block: horizontal 12, diagonal 14, vertical 16 and anti-diagonal 18. Multiple groups of lines or B-Features may be used or partitioned out of an image of the chart to form one or more “B-Blocks” 230 containing the same amount of bars in each direction as in a B-Feature with its four principle directions. In some embodiments the entire imaged chart is divided into B-Blocks. A B-Block may contain a footprint of the chart equal to one, two, three, four, five, six or more sided squares of B-Features. In some cases, it is not necessary that a B-Block contain whole B-Features, as long as the partitioning can be made such that each B-Block contains the same amount of bars 12-18 in each direction as in a B-Feature.

The size of the B-Chart along with the spatial frequency of the B-Feature (e.g., the period or frequency of adjacent lines of the chart) can be selected to match with the imaging system considering the system-to-B-chart distance (e.g., related to the period of the lines as imaged by the imaging system), image sensor pixel pitch, as well as the peak contrast sensitivity of the human visual system. When imaged by a system under test, the B-Chart provides sufficient amount of spatial detail in different directions (e.g., see B-Feature FIG. 2B) which can be effectively used by an image process or algorithm to precisely detect image quality defects in components of a given imaging system. The period of the line pairs (e.g., distance from leading edge of one line to leading edge of the adjacent line having similarly direction) in each direction is derived from a specific spatial frequency of interest, which is usually related to (or selected to be equal to) the pixel pitch of an image sensor component of the imaging system (or the imaging system itself) under test (e.g., period of adjacent lines is selected to be Fn/4 or Fn/2, where Fn is the Nyquist spatial frequency of the imaging system). Multiple spatial frequencies can be implemented by either using different charts each with a unique spatial frequency if the system-to-B-chart distance is fixed, or by just simply moving the original chart closer or further if the test distance is flexible (e.g., while keeping the full imaging field full of B-Chart Features).

According to embodiments, test elements 11 are formed across the whole area of the chart, such as to form a mosaic (See FIG. 2A) of a plurality of the visual elements, disposed adjacent to or abutting each other (See FIG. 2B). The chart may be a sharpness inspection area formed of a plurality of identical visual elements that abut each other leaving no gaps to thereby form a mosaic, wherein the visual element is a plurality of groups of differently oriented contrasting lines. For example the elements may fill the chart to form an unbroken edge of elements along edges 22, 24, 26 and 28 of chart 10. The chart may then be captured in an image by the imaging system, so that each of edges 22-28 are either at or beyond the outside edge or maximum imagable edges of an image frame, or of the full imaging field (“full field”) of the camera and/or imaging system.

Each of the visual elements may be groups of differently oriented contrasting (e.g., black and white) lines that abut each other leaving no empty spaces (See FIG. 2B) between each group. According to some embodiments, the lines of each group are parallel to each other and equal in thickness (e.g., black lines have the same thickness and there is equal spacing between them). It is considered that all of the lines of the visual elements (and of the entire chart) may have equal thickness. In some cases, each visual element has a square perimeter with a group of horizontal lines in the upper left 12, a group of diagonal lines in the upper right 14, a group of vertical lines in the lower right 16, and a group of anti-diagonal lines in the lower left 18 of the visual element (See FIG. 2B). In some cases, the chart is formed on or into a substrate; the visual elements are adjacent and abutting in the x and y directions of the area of the chart; and each visual element has four groups of different oriented black and white lines with four black lines. In some cases, there may be a group that is 4 horizontal black lines separated by 3 horizontal white lines; a group that is 4 diagonal black lines separated by 3 diagonal white lines and having 2 white diagonal corners; a group that is 4 vertical black lines separated by 3 vertical white lines; and a group that is 4 anti-diagonal black lines separated by 3 anti-diagonal white lines and having 2 white anti-diagonal corners. It is also considered that the positions of the four groups may be rearranged, such as to have the horizontal, diagonal, vertical and anti-diagonal lined groups in different quadrants of the feature, than what is shown in FIG. 2B. For instance, the location of the horizontal line group can be switched with that of the vertical, that of the diagonal or that of the anti-diagonal group. In addition, or independently, the location of the diagonal line group can be switched with that of the vertical, or that of the anti-diagonal group. Also, in addition, or independently of the switches above, the location of the vertical line group can be switched with that of the anti-diagonal group.

An advantage of this chart design is that the size of the chart along with the spatial frequency (e.g., spacing) of the visual element lines can be selected to test an imaging system's full field sharpness (the sharpness across the entire spatial extent of the captured image frame or across the whole area of the system's image capability) at selected spatial frequencies. The full field sharpness may be calculated based on or using the spatial frequency response and/or modulation transfer function of an image of the chart captured by the image system, where the entire frame the system is capable of imaging is filled with the image of the chart by the imaging system. For example, all of edges 22-28 may be located at the maximum width of the frame imaged by the system. In other cases, any or all of edges 22-28 may extend beyond the maximum width of the frame imaged. Thus, using chart 10, different aspects of image quality and analysis metrics from a given imaging system and its components may be more quickly and accurately determined by examining, testing or analyzing the entire full field (e.g., sharpness) of an image of the chart. For example a test process or system can use chart 10 to yield quality analysis metrics quickly and conveniently in order to maintain a low cost for performing the measurements, and to also have a thorough test of quality analysis metrics to identify detrimental degradations which could exist in the imaging system. Such analysis metrics may include full field image sharpness; sharpness uniformity, real-time sharpness uniformity visualization for setting focus of a fixed focus lens, and image tilt.

Chart 10 may be a test chart formed by printing lines of test elements (e.g., visual patterns) 11 on a piece of paper or forming the test elements on a substrate. For example, chart 10 may be formed by etching or printing the lines or blank spaces of patterns 11 on a substrate of plastic, silicon, cardboard, cellulose or metal. Other proper materials are also contemplated. In some cases, the printed material of the chart defines the function of the substrate upon which it is printed, such as by defining the frequency of the chart, in multiple directions, when imaged by imaging system 11. The chart pattern spacing and patternization may be selected and used for testing sharpness.

### Full Field Sharpness Map via B-Score:

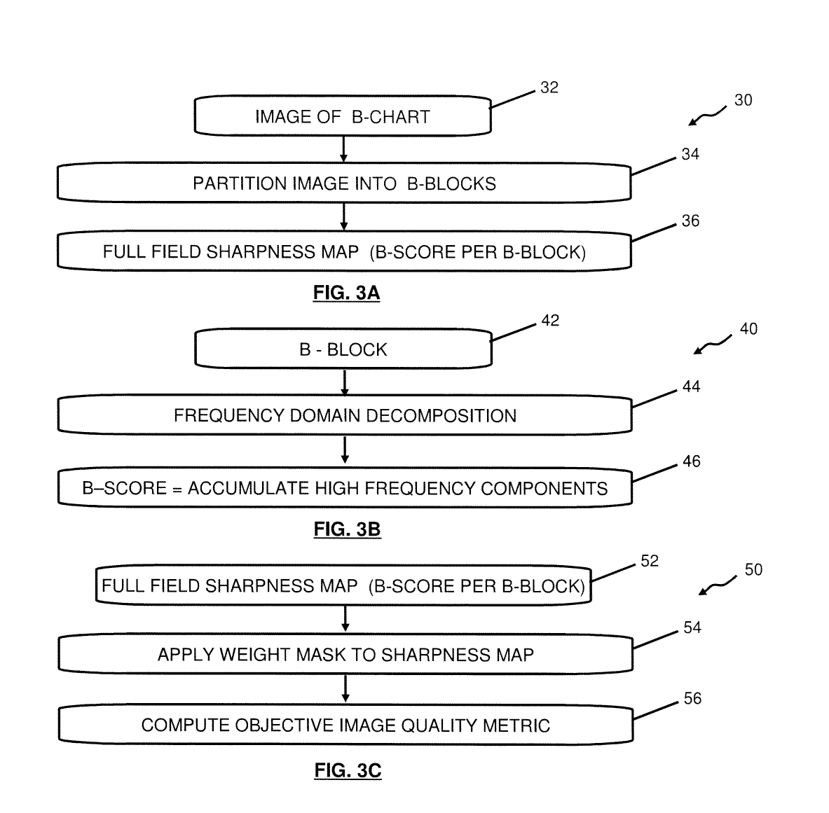

As compared to chart 10, prior conventional test systems and processes of objectively assessing a camera system's sharpness performance do not allow precise and accurate assessment of sharpness across the entire spatial extent of a captured image. For example, some prior charts for measuring digital camera resolution and sharpness via objective metrics computed from estimates of the spatial frequency response and/or modulation transfer function have spatial features at certain fixed chart locations, but lack fine spatial detail, especially in the plain solid white/gray portions of the chart. In the case of detecting local areas of sharpness non-uniformity, an image of such a prior chart captured using a camera with a sharpness non-uniformity defect co-located with the plain white portions may not reveal any problems with sharpness. Other popular prior charts used for sharpness assessment may includes edge features to objectively assess MTF performance, but the density of the edges is not great enough, and thus small local areas of image quality degradation may go undetected. In addition, other prior charts for assessing MTF performance also do not provide a dense enough set of spatial details to judge sharpness across the full field of the camera system. Thus, there is a lack of an available chart along with an image quality metric for objectively assessing a camera's full field sharpness. However, chart 10 (e.g., the B-Chart) and sharpness measure (e.g., the B-Score, see FIGS. 3A-C) address the problem of accurately judging the full field image quality performance of a given imaging system component via analysis of a full field relative sharpness map.

For example, FIG. 3A shows process 30 for using full field sharpness map construction to measure a camera or imaging system's full field sharpness from computed B-Scores of one or more captured B-Chart images. Also, FIG. 3B shows process 40 for using B-Score sharpness measure to measure a camera or imaging system's full field sharpness from computed B-Scores of one or more captured B-Chart images. In these processes, an image of a uniformly lit B-Chart captured with the imaging system under test can be analyzed to reveal its full field sharpness performance using a B-Score process or algorithm (e.g., see FIG. 3B).

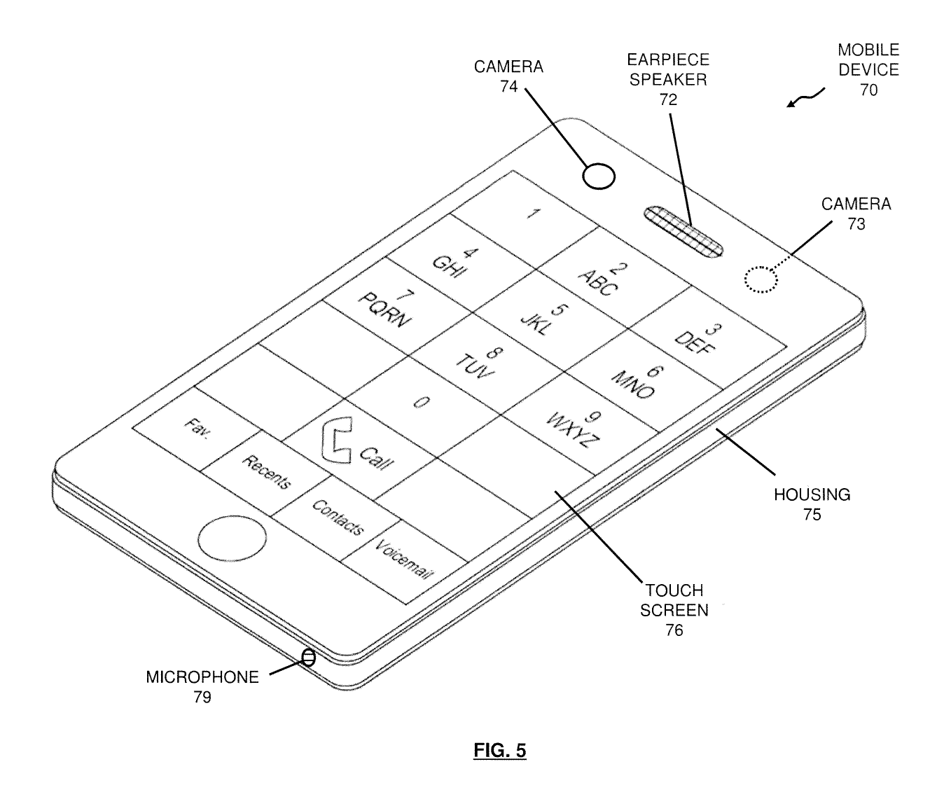

In FIG. 3A, at block 32 an image of a uniformly lit B-Chart (e.g., see FIG. 2A) is captured with the imaging system (e.g., FIG. 1) under test (e.g., see FIG. 5). This image can be analyzed to reveal its full field sharpness performance using the B-Score process or algorithm of FIGS. 3A-B. At block 34 the image (RAW Bayer or camera ISP processed YUV) is first partitioned into several B-Blocks. Partitioning may include selecting a block size and block locations throughout the entire x and y direction spatial extent of the image. The partitioning can be made such that each B-Block would contain the same amount of bars in each direction as in a B-Feature with its four principle directions. At block 36 the full field sharpness map (B-Score per B-Block) is calculated. Block 36 may include applying the B-Score process or algorithm to compute a B-Score from a certain channel of a color space representation of each B-Block (e.g. luminance or any other color channel of interest). To increase the sampling of the full field sharpness map, overlapped block or sliding window processing could be performed as well.

In FIG. 3B, at block 42 a B-Block is selected upon which to perform a B-Score. The B-Score process or algorithm (e.g., FIG. 3B) includes computing the sharpness within the extracted image B-Block as an accumulation of a measure of the block's high spatial frequency components in each of the four principle directions. At block 44, the separate measure of the block's high spatial frequency components in each of the four principle directions is measured or determined. Determining the components in each direction may include using electronics, an algorithm or a software process to filter out the other directions. At block 46 an accumulation of a B-Block's high spatial frequency components in each direction is computed. Accumulation of a B-Block's high spatial frequency components in each direction can be computed using standard frequency domain transformations such as Fast Fourier, Discrete Cosine, or Discrete Wavelet Transforms to obtain the frequency response in the frequency domain of the blocks. This can be followed by filtering and/or summing the resulting spectral coefficients. If the B-Block has been degraded by some unknown degradation process (e.g. lens defect, defocusing, contamination, etc) the amount of directional high frequency components will be decreased, leading to a lower B-Score for the block. The set of B-Scores for all partitioned B-Blocks can be considered as a relative sharpness map (tuned to the spatial frequency of the B-Chart as imaged by the system under test) across the entire spatial extent of the image frame. This sharpness map can be used to detect image quality degradations from a given component of an imaging system. Thus, it is possible to detect and identify a component that is functioning below acceptable specifications or is defective.

### Image Quality Analysis Metrics via Full Field Sharpness Map:

For example, there are many possible applications of a B-Chart/B-Score constructed full field sharpness map for use in analyzing image quality of a camera system. One general form of use of the full field sharpness map would be to first apply a multiplicative weight mask to the map prior to statistical analysis of certain map features to arrive at a single metric number for an image quality attribute of interest. FIG. 3C shows process 50 for applying B-Chart/B-Score constructed full field sharpness map to determine Image quality analysis metrics. At block 52, the full field sharpness map and B-Score per B-Block are obtained. At block 54, a multiplicative weight mask is applied to the full field sharpness Map to filter out certain map features, such as those noted below. At block 56, an objective image quality metric is calculated by performing a statistical analysis, such as to calculate a single metric number for an image quality attribute. It is considered that other processes or masks may also be used to filter out certain map features. As noted below, some examples of map features that can be filtered out and used to calculate an objective image quality metric are sharpness uniformity, real-time sharpness uniformity visualization for setting focus of a fixed focus lens, and image tilt.

### Sharpness Uniformity:

Using an image of chart 10, a sharpness uniformity metric can be computed using the full field sharpness map formed from B-Scores by considering the difference between the maximum sharpness map B-Score and the minimum sharpness map B-Score normalized by the average sharpness map B-Score. If the camera system exhibits uniform sharpness, the difference between the maximum and minimum sharpness map B-Scores (e.g., across an image of chart 10, or between adjacent B-Blocks) will be negligible (e.g., as known in the art), but if there is an area of localized sharpness drop indicated by sudden drop in sharpness map B-Score, then this metric may numerically reflect a sharpness non-uniformity. The constructed metric can be thresholded to classify cameras with good sharpness uniformity performance from those with non-uniform sharpness. The threshold can be set based on analyzing a training set of data collected from known limit samples containing cameras with good, bad, and marginal levels of sharpness uniformity. Such a classification scheme can be shown to correlate well with human perception. This process provides more accurate sharpness uniformity of the image system by considering B-Blocks within the full field of the imager to ensure uniformity amongst each block of the entire imageable area.

### Real-Time Sharpness Uniformity Visualization for Setting Focus of a Fixed Focus Lens System:

Due to size constraints, a fixed-focus camera may be the design choice for the camera feature in a given portable device. When a camera module is assembled, the focus of the lens system may be set by an iterative manual adjustment process (e.g., as known in the art). Using an image of chart 10, after each adjustment of the focus of the lens system, a full field sharpness map can be computed from captured image frames of the B-Chart. This map can be thresholded to classify sharp B-Blocks from those which remain blurred within the full field. In some examples, passing B-Blocks can be designated with the color green while failing B-Blocks can be designated with the color red within the full field. The full field thresholded map can then be visualized to provide real-time feedback to facilitate the setting of the focus of the fixed-focus lens system. Focusing has been completed after all B-Blocks are “green” within the full field. This process provides more accurate focusing of the image system by considering B-Blocks within the full field of the imager to ensure each block of the entire imageable area is in focus.

### Image Tilt:

Internal image tilt in the camera module can be detected by monitoring the shift in spectral peaks in the frequency domain decomposition (e.g., as known in the art). Using an image of chart 10, this process can consider each B-Block in the full field sharpness map. For 0 degree tilt, the spectral peaks of the B-feature will be located at the unique spatial frequency of the imaged B-Chart, the nominal chart frequency. For tilt away from 0 degrees, the spectral peaks will shift in the radial direction. The deviation of spectral peaks from the nominal chart frequency can then be used to detect image tilt for the full field. This process provides more accurate detection of image tilt of the image system by considering B-Blocks within the full field of the imager to ensure each block of the entire imageable area is not tilted.

Thus, the full field chart and sharpness measure disclosed in this document overcomes the limitations of the existing methods by providing a chart with a high density of spatial frequency details tuned to the imaging system under test along with an objective measure which accurately assesses the system's full field sharpness performance at the specific spatial frequency of the chart features.

For example, the spatial frequency response or modulation transfer function of B-Blocks of the full field of the imaging system can be determined by a test system or process to identify whether the imaging system, and possibly which of its components, are below design or fabrication specification. Such components include the optical lens assembly, entire camera module, camera image signal processing process or algorithm, components of FIG. 1, and the like. The test system or process may use electronics (e.g., a state machine, ROM, or dedicated circuitry logic) and/or software.

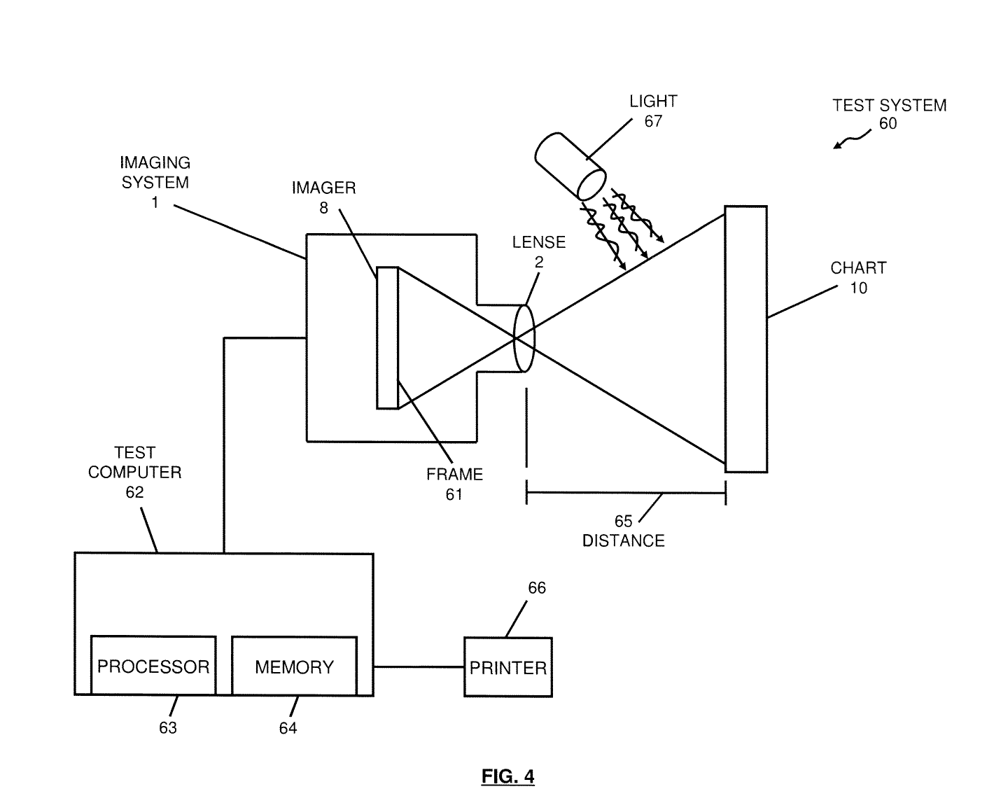

FIG. 4 is a representation of test system 60 that can be used for the monitoring and measurement of image quality of an image captured by a digital camera or imaging system, in accordance with embodiments of the invention. Test system 60 may be part of a high volume manufacturing production test line for imaging systems 11 or mobile devices (e.g., see device 70 of FIG. 5), which may be referred to as a device under test (DUT) being, in this case, imaging system 11. The test system positions imaging system 1 at predetermined or selected fixed distance 65 from test chart 10 which is lit by light 67. Light 67 may provide uniform light intensity and color across the area of the surface of chart 10. Light 67 may be deemed part of the test system in some cases. Imaging system 1 is operatively connected to test computer 62, such as using a data cable or wireless technology, so that computer 62 can receive digital image data of the image received or taken by imaging system 1 of the chart 10.

According to embodiments, test computer 62 has processor 63 and memory unit 64 (e.g., RAM) operatively connected to the processor for running a test program (e.g., computer program product) to perform the processed described herein. The memory unit may include a computer program product for measuring the full field sharpness performance of an image captured by a digital imaging system, the image comprising a chart. The test program may cause the test computer to measure the spatial frequency across an entire spatial extent (e.g., full field) of the captured image frame in the x and y directions, and to determine the spatial frequency response in different blocks of the entire spatial extent of the captured image frame in the x and y directions. Such determinations may include processes described herein (e.g., see FIGS. 1-3C). Test computer 62 may also have a non-volatile or tangible medium reader or input for receiving the test program.

Test computer 62 may optionally include or be connected to printer 66, such as using a data cable or wireless technology. The printer can be used to produce test chart 10, in accordance with embodiments of the invention. In some cases, a separate computer (e.g., a PC), or process may be used to produce test chart 10, in accordance with embodiments of the invention. Thus, test computer 62 may perform processes described herein including printing out a test chart and/or testing device 1.

The size (e.g., width and height) of the B-Chart 10 along with the spatial frequency of the B-Feature can be selected to match with the imaging system 1 considering the system-to-B-chart distance 65, the image sensor pixel pitch of system 1, as well as the peak contrast sensitivity of the human visual system (e.g., experimentally determined).

When imaged by a DUT system 1, the B-Chart 10 (e.g., an image evaluation chart) provides sufficient amount of spatial detail in different directions to be effectively used by test computer 62 to precisely detect image quality defects in components of the DUT imaging system. The period of the line pairs in each direction may be based on a specific spatial frequency of interest, which is related to the pixel pitch of the image sensor component of the imaging system under test (e.g., Fn/4 or Fn/2, where Fn is the Nyquist spatial frequency of the imaging system). In some cases, the specific spatial frequency of interest, period of the line pairs, and pixel pitch of the image sensor component may all be pre-determined or pre-selected before taking an image of the chart to test the DUT. Multiple spatial frequencies can be implemented by either using different charts each with a unique spatial frequency if the system-to-B-chart distance is fixed, or by just simply moving the original chart closer or further from the DUT, if the test distance is flexible.

Using chart 10 and/or system 60 may result in more accurate, efficient and reliable test data from the DUT. Using chart 10 and/or system 60 may include imaging system 1 taking an image of chart 10 (e.g., a “one shot” focused image of the chart) so that a mosaic formed across a whole area of the chart fills an entire image field or area of the image that is captured by an imager. The image data may then be sent by the system and/or received by test computer 62. In some cases, using system 60 may include preparing, producing, or printing chart 10. It may include selecting specific spatial frequency of interest, period of the line pairs, and pixel pitch of the image sensor, such as noted above. It may also include the test computer comparing resulting image data with thresholds to identify whether the sharpness of B-Blocks of the image are above or below acceptable sharpness thresholds or frequencies. The test system or computer can use the image taken by the imaging system of chart 10 to determine full field sharpness performance, as well as other analysis metrics, such as sharpness uniformity, real-time sharpness uniformity visualization for setting focus of a fixed focus lens, and image tilt. In some cases, an image of the chart can be used to compute a modulation transfer function of the imaging system, by computing a ratio of edge features of a captured image of the test chart, where the chart has lines spaced to test frequency response of the imaging system, so as to determine the full field sharpness of the system.

In some situations a test system or process can be used in a research laboratory or during manufactured device quality inspection to ensure a camera, camera module, or imaging system of a device has an acceptable sharpness and focus throughout and within its entire imagable full field. The test system or process may be particularly applicable for small form factor type cameras, such as those that are installed in a portable or mobile devices including a cellular telephone (such as an iPhone™ device by Apple Inc., of Cupertino Calif.), a laptop computer, a PDA, a computer notepad (such as an iPad™ device by Apple Inc., of Cupertino Calif.), or a stand alone digital camera. For example, low form factor or low profile portable or mobile devices may have a camera or imaging system that can be tested using the methods, target and systems described herein. The imaging system may be tested while in the mobile device or separately, such as prior to installation into the device.

In some embodiments, the “full field” may be described by an image of a test chart (e.g., chart 10) having visual elements formed across the whole area of the chart, where the image covers (e.g., fills, occupies, or takes up): (1) the maximum field of view or frame size of the imaging system; (2) the entire image field or area of an image that is captured by the imager; (3) the entire area of image sensor 8 that is processed by or that exists in an image produced by the imaging system; or (4) the entire spatial extent of the captured image frame in the x and y directions. For example, each of edges 22-28 of the chart (e.g., see FIG. 2) may be either at or beyond the outside edge or maximum imagable edges of sensor 8 of the camera, or of an image frame of the imaging system (e.g., so that the chart edges align with maximum field of view or frame size of the imaging system to provide a “full field” image of the chart). In some cases, all of edges 22-28 of the chart may be located at the maximum width of the frame 61 imaged by the system to provide or create a full field sharpness map and analysis/test. In other cases, any or all of edges 22-28 may extend beyond the maximum width of the frame imaged.

FIG. 5 shows an example mobile device 70 and circuitry in which embodiments of the imaging system can be implemented. The mobile device 70 may be a personal wireless communications device (e.g., a mobile telephone) that allows two-way real-time conversations (generally referred to as calls) between a near-end user that may be holding the device 70 against her ear, using a headset (not shown) or speaker mode (e.g., while taking a picture or video using a camera of the phone), and a far-end user. This particular example is a smart phone having an exterior housing 75 that is shaped and sized to be suitable for use as a mobile telephone handset. There may be a connection over one or more communications networks between the mobile device 70 and a counterpart device of the far-end user. Such networks may include a wireless cellular network or a wireless local area network as the first segment, and any one or more of several other types of networks such as transmission control protocol/internet protocol (TCP/IP) networks and plain old telephone system networks.

The mobile telephone 70 of FIG. 5 includes housing 75, touch screen 76, microphone 79, and ear-piece 72. During a telephone call, the near-end user may listen to the call using an earpiece speaker 72 located within the housing of the device and that is acoustically coupled to an acoustic aperture formed near the top of the housing. The near-end user's speech may be picked up by microphone 79 whose acoustic aperture is located near the bottom of the housing. Also included in the housing may be electronic components that interface with the speaker 72 and the microphone 79. The circuitry may allow the user to listen to the call through a wireless or wired headset (not shown) that is connected to a jack of mobile device 70. The call may include sending pictures or video taken with the imaging system. The call may be conducted by establishing a connection through a wireless network, with the help of RF communications circuitry coupled to an antenna that are also integrated in the housing of the device 70.

A user may interact with the mobile device 70 by way of a touch screen 76 that is formed in the front exterior face or surface of the housing. The touch screen may be an input and display output for the wireless telephony device. The touch screen may be a touch sensor (e.g., those used in a typical touch screen display such as found in an iPhone™ device by Apple Inc., of Cupertino Calif.). As an alternative, embodiments may use a physical keyboard may be together with a display-only screen, as used in earlier cellular phone devices. As another alternative, the housing of the mobile device 70 may have a moveable component, such as a sliding and tilting front panel, or a clamshell structure, instead of the chocolate bar type depicted.

According to embodiments, one or more of imaging system 1 of FIG. 1 may be installed into device 70. For example, device 70 is shown having camera 73, such as one of imaging system 1, mounted to capture images of objects below the bottom surface of housing 75. In some cases, device 70 has camera 74, such as one of imaging system 1 mounted to capture images of objects above the top surface of housing 75. It is also possible for device 70 to have both, camera 73 and 74. In this case the cameras may each be part of separate imaging systems 1; or may have separate lens 2 and sensor 8, but share the other components or circuitry of the imaging system. Thus, camera 73 and/or 74 may be used to capture still images or video to be stored and/or transmitted via SMS, email, or phonecall by device 70. The video may have frames synchronized in time with audio input from microphone 79 or a microphone of a headset. The mobile device 70 may allow two-way calls between a near-end user taking video using camera 74 of the phone, and a far-end user possibly also taking video to perform video conferencing or chatting.

It should be understood that the present embodiments of imaging system could be incorporated on a wide variety of mobile telephones 70. It is also noted that imaging system 1 could be incorporated into devices such as personal digital assistants, personal computers, and other mobile and non-mobile devices (e.g., security systems, and mounted cameras).

Furthermore, it should also be noted that in some cases, the test systems or processes described herein can be run on a device such as a mobile telephone 70. In this case the test may be used to test, calibrate and/or repair an imaging system or component (e.g., as related to analysis metrics tested, such as noted for FIGS. 1-4) that is already installed on device 70. In other cases, the mobile telephone 70, other mobile device or imaging system may be used only for capturing the image, after which the processes of the present embodiments is performed or run on another “test system” device such as including a test computer (e.g., see FIG. 4).

Some embodiments of the present invention may be described in the general context of test processes or systems. In some embodiments, the test processes or systems may be implemented by (or include) a program product including computer-executable instructions (e.g., software program instructions), such as program code or instruction, to be executed by a computer. The program product may be instructions stored on a non-volatile or tangible medium configured to store or transport the instructions, or in which computer readable code may be recorded or embedded. Some examples of computer program products are flash drives, USB drives, DVDs, CD-ROM disks, ROM cards, floppy disks, magnetic tapes, computer hard drives, and server storage on a network. For instance, an embodiment of the invention can be implemented as computer software in the form of computer readable code (e.g., read from a non-volatile or tangible medium and) executed by test computer 62 illustrated in FIG. 4. It can also be implemented on a laptop computer, a PC (e.g., by Apple Inc., of Cupertino Calif., or another manufacturer), or in the form of bytecode class files running on such a computer. Such a computer may perform the processes described herein with respect to FIGS. 1-3, such as testing an imaging system using its full field performance and/or printing out a test chart, B-Chart.

Some embodiments include a test system having a processor and a memory unit operatively connected to the processor, the memory unit including computer program instructions for measuring the full field sharpness performance of a digital imaging system. The computer program instructions (e.g., when executed by the processor) are able to measure the spatial frequency across an entire spatial extent of an image, captured by the imaging system, of a test chart, wherein the chart comprises a mosaic of a plurality of abutting visual elements, wherein each of the visual elements is a plurality of groups of differently oriented contrasting lines, the mosaic is to fill the entire spatial extent of the captured image; and determine spatial frequency response in different blocks of the entire spatial extent of the captured image frame.

It also is considered that the program products, test programs and instructions mentioned herein may be embodied in a computer-readable medium storing data and instructions to cause a programmable processor to perform operations described. The medium may be tangible and/or non-volatile. The test program (e.g., program product) may cause a test computer or other device to measure the spatial frequency across an entire spatial extent (e.g., full field) of the captured image frame in the x and y directions, and to determine the spatial frequency response in different blocks of the entire spatial extent of the captured image frame in the x and y directions. In some cases, the test program includes code for selecting a block size and block locations throughout the entire x and y direction spatial extent of the image; partitioning the image into a plurality of the blocks based on the block size and locations; performing a frequency response transformation on the image to obtain the frequency response in the frequency domain of the blocks; filtering the blocks to remove the low frequency components; obtaining the frequency response or modulation transfer function of each block; and accumulating overall score of the high frequency scores of each block to determine an overall full field sharpness performance of the imaging system. Filtering the blocks may include high pass filtering to remove DC components. For cases where each visual element has four principle directions of the differently oriented contrasting lines, obtaining the frequency response or modulation transfer function of each block may include obtaining a separate frequency response for each of the four different directions of each block, and accumulating an overall score may include accumulating the frequency response or modulation transfer function of all of the four different directions of each block. For some embodiments determining the (e.g., full field) sharpness performance includes determining an overall full field score for the entire area of the image, determining a sharpness map of each block for the entire field/image, and making a comparison of the response of each block to the overall score and/or to adjacent regions/blocks.

In some embodiments, determining an overall full field sharpness performance may include using the accumulated overall score of the high frequency scores of each block to determine an image quality metric of the imaging system. In some cases determining the full field sharpness performance may include measuring a tilt of the image using data from all of the blocks; or a calculation or calibration of a focus position based on the frequency response of the entire image and of each block. For some situations, determining the full field sharpness performance includes filtering out image data for a selected map feature; and using the filtered out data to calculate an objective image quality metric, wherein the metric is one of a sharpness uniformity, a real-time sharpness uniformity visualization for setting focus of a fixed focus lens, and an image tilt.

Embodiments may also include testing the performance of an optical system through the measurement of image quality in a digital imaging system that contains the optical system. An image of a test chart captured by the image system may be used to assess full field sharpness performance of the imaging system.

In some cases,the image and/or chart has a sharpness inspection area formed of a plurality of identical visual elements that abut each other leaving no gaps to thereby form a mosaic, wherein the visual element is a plurality of groups of differently oriented contrasting lines. In some embodiments, the image may include a mosaic of the test chart formed across a whole area of an image field of the image, the mosaic comprising a plurality of abutting visual elements, wherein each of the visual element is a plurality of groups of differently oriented contrasting lines. In some situations, a first set of the visual elements has a first set of outer edges that do not abut other visual elements and that define outer edges of the chart; and wherein all outer edges of the visual element that are not in the first set abut other outer edges of an adjacent visual elements.

Embodiments may also include a test chart for assessing full field sharpness performance of an imaging system, where the chart has a mosaic formed across a whole area of the chart to fill an entire image field or area of an image that is captured by an imager. The mosaic may include a plurality of abutting visual elements, wherein each of the visual element is a plurality of groups of differently oriented contrasting lines. For instance, there may be no empty space between any of the visual elements, and there is no empty space between the contrasting lines.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the test process has been described in connection with the embodiments of FIG. 4, a similar process can be implemented using portable device having the imaging system installed therein, or using a PC, such as by a repair technician, or owner of device 70, to test, repair or recalibrate the device's imaging system.

What is claimed is:

1. A test chart for assessing sharpness performance of an imaging system, the chart comprising:
a sharpness inspection area formed of a plurality of identical visual elements that abut each other leaving no gaps to thereby form a mosaic, wherein the visual element is a plurality of groups of differently oriented contrasting lines.

2. The apparatus of claim 1, wherein the visual element has a square perimeter.

3. The apparatus of claim 1, wherein the groups of contrasting lines comprise a group of horizontal lines, a group of diagonal lines, a group of vertical lines, and a group of anti-diagonal lines.

4. The apparatus of claim 3, wherein the visual element has a square shape perimeter, the group of horizontal lines are in the upper left, the group of diagonal lines are in the upper right, the group of vertical lines are in the lower right, and the group of anti-diagonal lines are in the lower left of the visual element.

5. A system for assessing full field sharpness performance of an imaging system comprising:
a processor and a memory unit operatively connected to the processor, the memory unit including computer program instructions for measuring the full field sharpness performance of a digital imaging system, wherein the computer program instructions, when executed by the processor:
measure the spatial frequency across an entire spatial extent of an image, captured by the imaging system, of a test chart, wherein the test chart comprises a mosaic of a plurality of abutting visual elements, wherein each of the visual elements is a plurality of groups of differently oriented contrasting lines, the mosaic is to fill the entire spatial extent of the captured image; and
determine spatial frequency response in different blocks of the entire spatial extent of the captured image frame.

6. The system of claim 5, wherein the computer program instructions, when executed by the processor:
select a block size and block locations throughout the entire x and y direction spatial extent of the image;
partition the image into a plurality of the blocks based on the block size and locations;
perform a frequency response transformation on the image to obtain the frequency response in the frequency domain of the blocks;
filter the blocks to remove the low frequency components;
obtain the frequency response or modulation transfer function of each block; and
accumulate overall score of the high frequency scores of each block to determine an overall full field sharpness performance of the imaging system.

7. The system of claim 6, wherein each visual element has four principle directions of the differently oriented contrasting lines;
wherein obtaining the frequency response or modulation transfer function of each block includes obtaining a separate frequency response for each of the four different directions of each block; and
wherein accumulating overall score comprises accumulating the frequency response or modulation transfer function of all of the four different directions of each block.

8. The system of claim 6, wherein filtering the blocks comprises high pass filtering to remove DC components.

9. The system of claim 6, wherein determining the overall full field sharpness performance includes:
determining an overall score for the image;
determining a sharpness map of each block for the entire field/image;
making a comparison of the response of each block to the overall score and/or to adjacent regions/blocks.

10. The system of claim 6, wherein determining the overall full field sharpness performance includes:
measuring a tilt of the image using data from all of the blocks, or
calculating a focus position based on the frequency response of the entire image and of each block.

11. The system of claim 6, wherein determining the full field sharpness performance includes:
filtering out image data for a selected map feature; and
using the filtered out data to calculate an objective image quality metric, wherein the metric is one of a sharpness uniformity, a real-time sharpness uniformity visualization for setting focus of a fixed focus lens, and an image tilt.

12. The system of claim 5, wherein the test chart has no empty space between the visual elements, and there is no empty space between the contrasting lines; and wherein the groups of contrasting lines comprise a group of horizontal lines, a group of diagonal lines, a group of vertical lines, and a group of anti-diagonal lines.

13. The system of claim 12, wherein each visual element has a square shape perimeter, the group of horizontal lines are in the upper left, the group of diagonal lines are in the upper right, the group of vertical lines are in the lower right, and the group of anti-diagonal lines are in the lower left of the visual element.

14. An article of manufacture comprising:
a tangible computer-readable medium storing data and instructions that cause a programmable processor to:
measure the spatial frequency across an entire spatial extent of an image, captured by the imaging system, of a test chart, wherein the chart comprises a mosaic of a plurality of abutting visual elements, wherein each of the visual elements is a plurality of groups of differently oriented contrasting lines, the mosaic is to fill the entire spatial extent of the captured image; and
determine spatial frequency response in different blocks of the entire spatial extent of the captured image frame.

15. The article of manufacture of claim 14, wherein the instructions cause a programmable processor to:
select a block size and block locations throughout the entire x and y direction spatial extent of the image;
partition the image into a plurality of the blocks based on the block size and locations;
perform a frequency response transformation on the image to obtain the frequency response in the frequency domain of the blocks;
filter the blocks to remove the low frequency components;
obtain the frequency response or modulation transfer function of each block; and
accumulate overall score of the high frequency scores of each block to determine an overall full field sharpness performance of the imaging system.

16. The article of manufacture of claim 15, wherein each visual element has four principle directions of the differently oriented contrasting lines;
wherein obtaining the frequency response or modulation transfer function of each block includes obtaining a separate frequency response for each of the four different directions of each block; and
wherein accumulating overall score comprises accumulating the frequency response or modulation transfer function of all of the four different directions of each block.

17. The article of manufacture of claim 15, wherein filtering the blocks comprises high pass filtering to remove DC components;

18. The article of manufacture of claim 15, wherein determining the full field sharpness performance includes:
determining an overall score for the image;
determining a sharpness map of each block for the entire field/image;
making a comparison of the response of each block to the overall score and/or to adjacent regions/blocks;

19. The article of manufacture of claim 15, wherein determining the full field sharpness performance includes:
measuring a tilt of the image using data from all of the blocks, or
calculating a focus position based on the frequency response of the entire image and of each block.

20. The article of manufacture of claim 15, wherein determining the full field sharpness performance includes:
filtering out image data for a selected map feature; and
using the filtered out data to calculate an objective image quality metric, wherein the metric is one of a sharpness uniformity, a real-time sharpness uniformity visualization for setting focus of a fixed focus lens, and an image tilt.
